(19) United States
(12) Patent Application Publication
(10) Pub. No.: US 2015/0173154 A1
(43) Pub. Date: Jun. 18, 2015

(54) COMMISSIONING METHOD AND APPARATUS

(71) Applicant: NXP B.V., Eindhoven (NL)

(72) Inventor: Colin Faulkner, North Kykeham (GB)

(21) Appl. No.: 14/486,055

(22) Filed: Sep. 15, 2014

(30) Foreign Application Priority Data
Dec. 17, 2013 (EP) 13197675.5

(51) Int. Cl. H05B 37/02

(52) U.S. Cl. CPC H05B 37/0218

(57) ABSTRACT

A lamp controller 100 for a lamp in a lighting network has a commissioning mode of operation and transmits an identity of the lamp by modulating the light. This identity information may be detected by a detector already on the network which has a photosensor. The detector may then securely pass the information to the network to commission the lamp controller into the lighting network.

### FIELD

This disclosure relates to a lamp controller for a lamp in a lighting network and a method and apparatus for commissioning a lamp into a network.

### BACKGROUND

Lamp controllers for lighting networks typically include radio frequency (RF) transceivers or transponders to form wireless networks with many such devices. Such a network may also include a central server or gateway and other control devices such as switches. Lamps including the lamp controllers and a light source are configured to operate together in a network and may be individually controlled by communicating control and data commands via the network in domestic or commercial buildings. The lamp controllers can be configured, for example, as a node in an IEEE802.15.4 or Zigbee personal area network. The lamp controller typically contains a microprocessor and radio transceiver or transponder together with various peripherals and memory. These may be integrated into a single semiconductor device. An IEEE 802.15.4 based lighting network will typically have light switches incorporating IEEE802.15.4 end devices, whereas the light fitments incorporate IEEE802.15.4 router nodes which both control their own light and operate as routers, routing messages to other nodes.

When installing wirelessly connected lighting systems which may operate according to the Zigbee protocol or a proprietary protocol such as the NXP Jennet-IP protocol, it is difficult to communicate the security keys used in a secure manner without sending at least one of the keys in the clear such that it can be received and decoded by a malicious intruder device within radio range. Current wireless lighting control systems rely on either a commissioning key being sent in the clear briefly during the commissioning process, or on use of a “secret” shared key, or by using a key that is derived from the device address by some algorithm. For example by rearranging the device address according to a predetermined method.

A short range technique for sharing a key by RF near field communication (NFC) has been used. This reduces the risk that the key can be detected by an intruder device. However, this involves adding a cost to lamps since a separate antenna and hardware may be required.

### SUMMARY

Various aspects of the invention are defined in the accompanying claims. In a first aspect there is defined a lamp controller for a lamp in a lighting network, the lamp controller having a commissioning mode of operation and a normal mode of operation and comprising a transponder, a memory for storing commissioning information; and a processor coupled to the light source, the transponder and the memory, wherein the lamp is operable in the commissioning mode to transmit the commissioning information by modulating the light output of a light source coupled to the lamp controller, and to receive a network key via the transponder and wherein the lamp is operable in the normal mode to communicate with other nodes in a lighting network via the transponder.

In order to join a network of lamps in a lighting network, two pieces of information generally need to be transferred; i) the system needs to know that a lamp controller is trying to join is bona fide and is expected, and ii) the system needs to share its security or network keys with the lamp in a secure fashion. Both of these pieces of information can be conveyed by using on/off modulation of the lamp light source. This may allow a more secure commissioning procedure without adding additional hardware.

In embodiments, the commissioning information may comprise an address of the lighting apparatus such as an internet protocol address or a MAC address. The commissioning information may include other information to uniquely identify the lamp controller, such as a unique commissioning key.

In embodiments, the commissioning information may comprise a commissioning security key. The commissioning security key may be used for example by a server or gateway on the network to encrypt the network key before retransmission back to the lamp via the transponder.

In embodiments the lamp controllers may form part of a RF wireless network and communicate using the Zigbee or Jennet IP protocol.

In embodiments, the lamp controller may be included in a lamp and coupled to a light source.

In a further aspect, there is defined a detector for commissioning a lamp controller for a lamp in a lighting network, the detector comprising a photosensor, a transponder, and a controller coupled to the photosensor and the transponder; wherein the detector is operable to detect commissioning information transmitted from a light source coupled to the lamp controller via the photosensor, and to transmit the received commissioning information via the transponder.

The detector may be an existing node on the network and so can communicate network information to the lamp being commissioned directly or via another node such as a server or gateway device such as a Wi-Fi router.

In embodiments the detector is further operable to transmit a location of the detector corresponding to the location of a lamp in response to detecting the commissioning information. Since the detector generally has to be in an optical line of sight of the light source of a lamp being commissioned, and the lamp is installed in position in the building, there may be a correlation between the position of the detector and the lamp being commissioned. If the detector is a portable device, for example it may be positioned directly under the lamp being commissioned. This allows the position or location of the lamp to be determined automatically and logged within the network when installed.

In embodiments the detector may comprise an orientation sensor and the detector is further operable to determine a location of a lamp from the location and orientation of the detector in response to detecting the commissioning information. Using the orientation may allow multiple lamps to be commissioned from a single location by directing the detector towards a specific light source coupled to a lamp controller.

In embodiments the detector is further operable to wirelessly transmit data for determining a time-of-flight from the detector to at least two transponders, each of the at least two transponders having a predetermined fixed location, wirelessly receiving data for determining a time-of flight from each of the two lamps being commissioned, determine a distance between the detector and each of the at least two transponders, determine the location value of the detector from the determined distances.

In a lighting network having two fixed known points of reference, it may be possible to automatically determine the position of the detector, and therefore a location of a lamp or lamp controller.

In embodiments, the detector may be a mobile phone. The camera of the mobile phone may be used as a photosensor if the frequency of the modulated light output is low. This may for example be below 30 Hz.

In a further aspect there is defined a method for commissioning a lamp into a network, the lamp controller comprising a transponder, the method comprising configuring the lamp controller into a commissioning mode of operation; configuring the lamp controller to modulate the light of a light source coupled to the lamp controller to transmit commissioning information, receiving an encrypted network key via the lamp transponder, and configuring the lamp controller into a normal mode of operation; wherein in the normal mode of operation the lamp controller communicates with other network devices on the network via the transponder.

Embodiments of the invention are now described in detail, by way of example only, illustrated by the accompanying drawings in which:

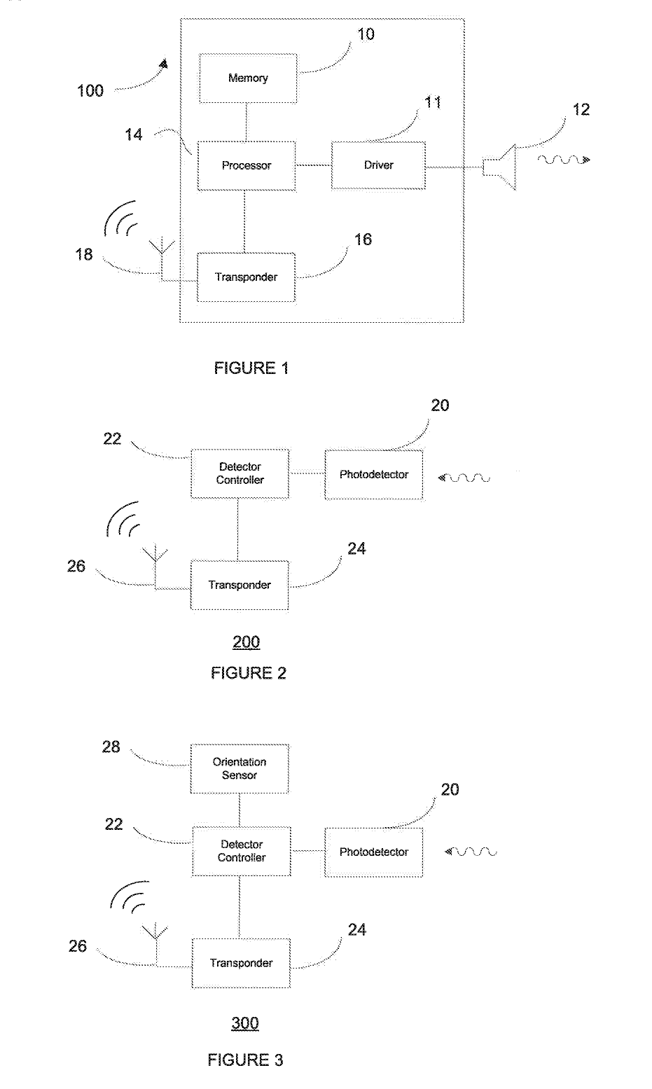

FIG. 1 shows a lamp controller according to an embodiment.

FIG. 2 illustrated a detector according to an embodiment.

FIG. 3 shows a detector with an orientation sensor according to an embodiment.

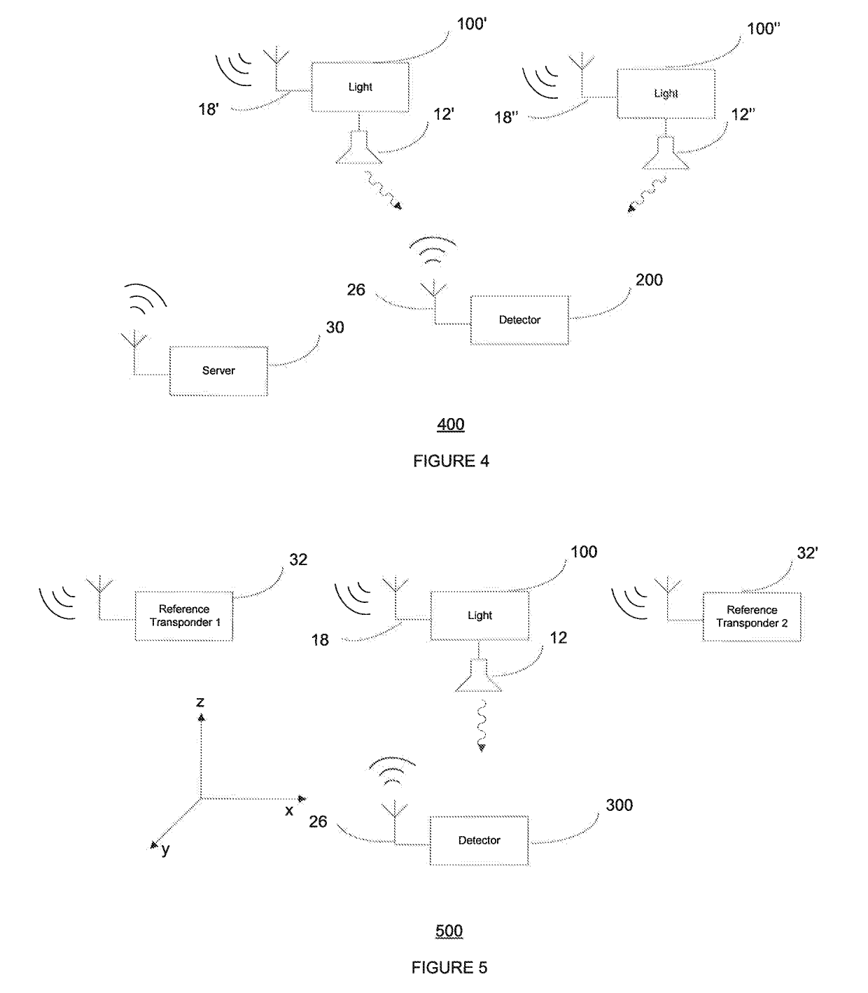

FIG. 4 illustrates a lighting network according to an embodiment.

FIG. 5 shows a lighting network with reference transponders according to an embodiment.

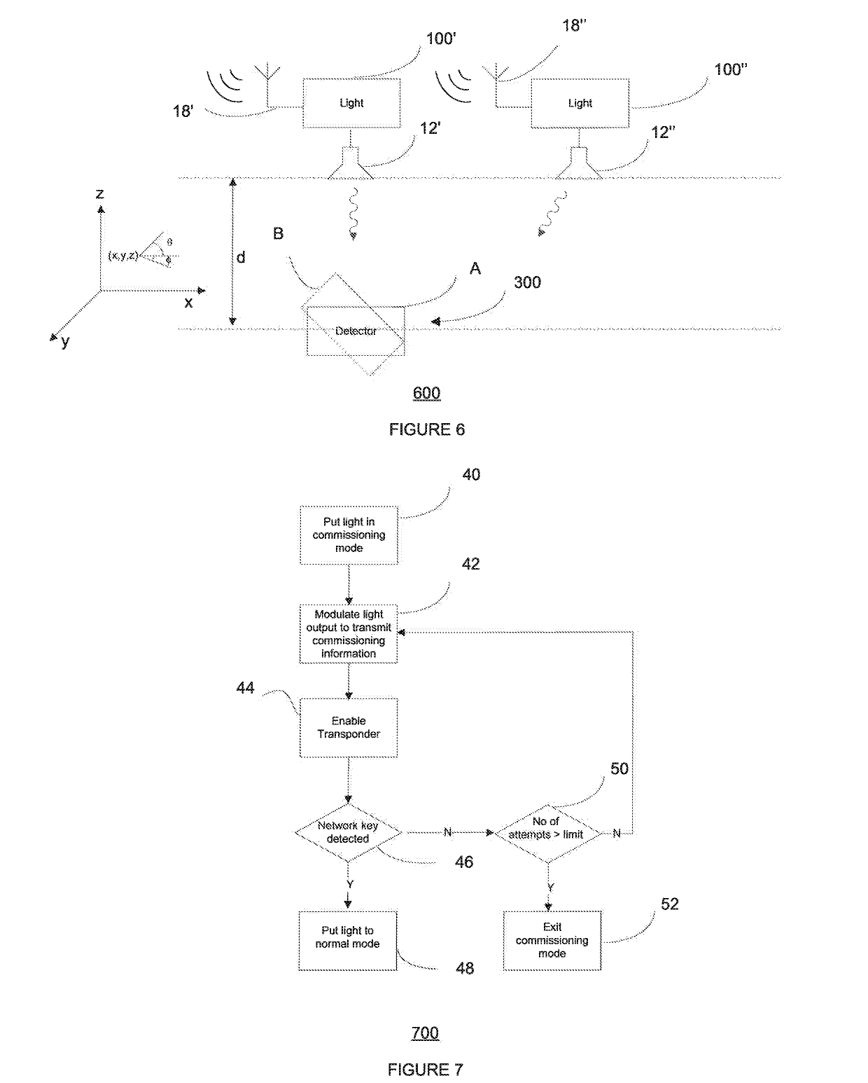

FIG. 6 illustrates a lighting network with the detector of FIG. 3 according to an embodiment.

FIG. 7 shows a method of operation of a lamp controller during commissioning according to an embodiment.

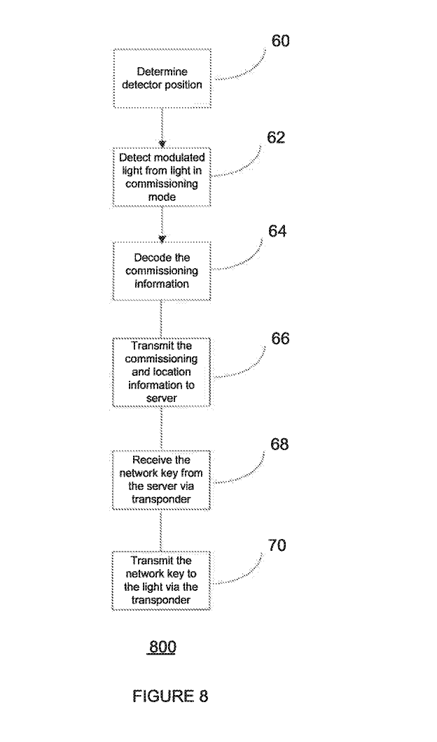

FIG. 8 shows a method of operating a detector during commissioning of a lamp controller into a network according to an embodiment.

### DESCRIPTION

FIG. 1 shows a lamp controller 100. A memory 10 may be connected to a processor 14. The controller 14 may be connected to a light source driver 11. The processor 14 may also be connected to a transponder 16. The memory 10 may contain the identity code, commissioning security key and other information such as the address of the device which may be an internet protocol (IP) address or a MAC address. The skilled person will appreciate that the lamp controller 100 is operable as part of a lighting network in normal operation. To join the network, which typically happens after lamp controller 100 has been installed in a building, the lamp controller 100 may be set in a commissioning mode. The lamp controller 100 may enter a commissioning mode of operation for example when a lamp including the lamp controller is new or following a factory reset. In the commissioning mode the lamp controller 100 may attempt to join a network by requesting to join over the network communications medium such as, for example, Zigbee.

During the commissioning mode, the processor 14 may control the light source driver 11 to modulate a light source 12 which may be connected to the lamp controller 100 and be comprised in the lamp. The modulation may be used to transmit commissioning information stored in the memory 10. The commissioning information may include lamp identity and unique security information. The commissioning information may be received by a light detector or camera in view of the light source 12 and conveyed securely to the network by a commissioning device that is already a member of the network and hence is securing all its transmissions with the network security, or by a mobile device securely connected to the lighting network over another network. On receiving this data, the network may compare the received identity information with identity information transmitted over the network communications medium via transponder 16. In this way, the network may verify that the lamp identity seen is the same as that for the one expected to join. Since the light source 12 must be in line of sight with the detector, this may provide a secure method of commissioning a lamp controller 100 in the network. The network may also use the commissioning information to derive a unique commissioning key. The unique commissioning key can be sent “in the clear” using the light modulation as this has a restricted coverage area and is hard to intercept, or it may be modified by an algorithm known to both the lamp and the network. This unique commissioning key may then be used to securely send the network key to the lamp controller 100. The network key may be detected by transponder 16 via an antenna 18, thus providing a more secure method of joining the network. The skilled person will appreciate that a lamp controller may be connected to a network wirelessly or via a network cable. The frequency of the light modulation may be above 70 Hz so that it is not detectable by the human eye. The lamp controller 100 may be implemented for example by software running on a microprocessor such as that contained in NXP Semiconductor's JN5168 device, which also has memory and a transponder. The lighting driver 11 may be implemented for example using a dedicated driver circuit such as NXP Semiconductor's 5512108 series of devices. Alternatively, any other circuit suitable for driving a light source may be used as a lighting driver circuit. Some light sources may be driven directly by the processor 14 in which case the separate lighting driver may be omitted.

The skilled person will appreciate that processor 14 may be implemented in hardware, software or a combination of hardware. The processor may for example be implemented as software running on a microprocessor or dedicated logic. A lamp for a lighting network may be formed by connecting the light driver to the light source 12 and the transponder 16 to an antenna 18.

FIG. 2 shows a detector 200. A photosensor or photodetector 20 may be connected to a detector controller 22. Detector controller 22 may be connected to a detector transponder 24 which may be a RF transponder connected to an antenna 26. The photosensor 20 may be a photodiode or other photosensitive array such as used in a camera. The photosensor 20 may be housed in a tube which is directed towards the lamp being commissioned. During commissioning of a lamp controller 100 the detector 200 may detect the commissioning information. The detector 200 may already be commissioned into the network and consequently may transmit the commissioning information securely to the network. The detector 200 may also be part of a further network, for example a Wi-Fi network and may transmit the commissioning information over the further network. The photosensor 20 of the detector 200 must be in line of sight of the light source 12 connected to the lamp controller 100 being commissioned. Consequently, if information regarding the location of the detector 200 is known, then information regarding the location of the lamp may be determined. The location information or value may be transmitted to other devices on the network by detector 200.

FIG. 3 shows a detector 300. A photosensor 20 may be connected to a detector controller 22. The detector controller 22 may be connected to a detector transponder 24 which may be a RF transponder. The detector transponder may be connected to an antenna 26. An orientation sensor 28 may be connected to the detector controller 22. The photosensor 20 may be a photodiode or other photosensitive array such as used in a camera. The photosensor 20 may be housed in a tube which is directed towards the lamp controller being commissioned. During commissioning of a lamp controller 100 the detector 200 may detect the commissioning information. The detector 200 may already be commissioned into the network and consequently may transmit the commissioning information securely to the network. The detector 200 may also be part of another network, for example Wi-Fi and may transmit the commissioning information over that network. The photosensor 20 of the detector 200 must be in line of sight of the lamp being commissioned. Consequently, if information regarding the location of the detector 200 is known, then information regarding the location of the lamp may be derived and included together with the commissioning information transmitted to the network by the detector 200. The detector 300 must be in the line-of-sight of the lamp being commissioned. The detector 300 must be oriented such that the photosensor 20 can detect the light. Hence, if the position of the detector 300 is known, the orientation determined by the orientation sensor 28 may be combined with the known location of the detector 300 to determine a location of the lamp controller being commissioned

The orientation sensor 28 may be implemented using one or more accelerometers. The detector 300 may be implemented on a Smartphone.

FIG. 4 shows an example lighting network 400 which includes two lamp controllers 100′ and 100″ previously described in FIG. 1 together with a network server or gateway 30 which may include an RF transponder, and a detector 200. The detector 200 may be authenticated on the network by the gateway 30. During the commissioning process, the detector 200 may be positioned to detect modulated light from one of the light source 12′ and 12″. The detector 200 may detect the modulated light output from light source 12′ which contains the commissioning information of the lamp controller 100′. The detector 200 may transmit the commissioning information for the lamp controller 100′ via an RF transponder to the gateway 30 which may store a network key. The gateway 30 may transmit the network key to lamp controller 100′. The commissioning information may include a security key. The network key may be encrypted using the security key and then transmitted to the lamp controller 100′ via the RF wireless transponder. The lamp controller 100′ may receive the encrypted information and extract the network key which is subsequently stored in memory. The skilled person will appreciate that the lamp controller 100′ may now transmit and receive information via the RF transponder as part of the wireless lighting network 400. The skilled person will appreciate that the lamp controller 100″ may be similarly commissioned into the lighting network 400. The detector 200 may be disconnected from the wireless lighting network following the completion of the commissioning process. The gateway 30 may be a Wi-Fi router. The skilled person will appreciate that a lighting network may include a network of lamp controllers together with other network nodes including devices for building controls such as heating and security.

FIG. 5 illustrates a lighting network 500 having a first wireless reference transponder 32 and a second wireless reference transponder 32′ having known locations within a building. These transponders 32 and 32′ could be, for example, previously installed lights having wireless transponders, wireless routers, or dedicated location transponders. Detector 200 may use time-of-flight techniques such as described in US patent application, publication number 2010/0081389A1 to establish a detector location. The detector 200 may transmit data with a timestamp to the first wireless reference transponder 32 and the second wireless reference transponder 32′. The first wireless reference transponder 32 and the second wireless reference transponder 32′ respectively may retransmit the data back to the detector 200. The detector 200 may then determine the time of flight from the difference between the time the data was received and the timestamp in the data packet sent.

During the commissioning process of lamp controller 100, the detector 200 may be positioned directly under light apparatus 100. The position of the detector 200 according to the Cartesian coordinates X,Y during the commissioning process may therefore be considered to correspond to the X; Y coordinates of the lamp controller 100. The detector 200 may combine the location information with the commissioning information before retransmission of via the RF transponder to a server (not shown). In this way, the location of the lamp controller 100 may be automatically logged during the commissioning process. The detector 200 may be disconnected from the network 500 following completion of the commissioning process.

FIG. 6 shows a lighting network 600 which may include a lamp controller 100′, a further lamp controller 100″ and detector 300 shown in a first orientation A to detect light during commissioning of lamp controller 100′ and in a second orientation B during commissioning of further lamp controller 100″. The detector 200 may have at least location coordinates X,Y predefined by a user, or may determine its location using a time-of-flight technique, for example as previously described for lighting network 500. The distance d from the detector to the ceiling of the room may also be predetermined. The orientation sensor 28 in detector 300 may be used to determine the value of angles Φ and θ when the detector is in orientation A and orientation B. Hence, the skilled person will appreciate that a location of the light apparatus 100′ and 100″ may be derived from the X; Y coordinates of the detector 300 in combination with distance d and the values of Φ and θ.

FIG. 7 illustrates an example method of operation 700 of a lamp controller for a lamp in a lighting network. The lamp controller may enter a commissioning mode of operation in step 40. In step 42 commissioning information may be transmitted by modulating the light output of a light source connected to a lamp controller, for example by switching the light on and off. The commissioning information may be transmitted to the network by a detector which detects the modulated light. In step 44 a transponder may be enabled to listen for any response from the network to the transmission of the commissioning information. The transponder may demodulate and decode any received RF signal. The transponder may be an RF transponder. A check for an encrypted network key may be made in step 46. If a network key is detected then the lamp may change to a normal mode of operation in step 48. If a network key is not detected in step 46 then in step 50 a comparison may be made against the number of attempts to transmit the commissioning key without a response. If the number of attempts or retries exceeds a predetermined limit, then the commissioning mode may be exited in step 52 and the lamp may switch off. If the predetermined number of retries is not exceeded, then the method reverts to step 42 and the commissioning information may be re-transmitted.

FIG. 8 shows an example method of operation 800 of a detector for commissioning a lamp in a lighting network. A detector position may be determined in step 60. This may be predetermined by a user or determined by other means such as time-of-flight and/or detector orientation. In step 62 the modulated light from the lamp in commissioning mode may be detected by a photosensor. In step 64 the commissioning information may be demodulated and decoded by the detector. The commissioning information together with the location information may then be transmitted to a network server or gateway on the lighting network, in step 66. In step 68, the detector may receive the network key from the server via an RF transponder. In step 70 a network key may be transmitted to the lamp.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub combination.

The applicant hereby gives notice that new claims may be formulated to such features and/or combinations of such features during the prosecution of the present application or of any further application derived therefrom.

For the sake of completeness it is also stated that the term “comprising” does not exclude other elements or steps, the term “a” or “an” does not exclude a plurality, a single processor or other unit may fulfil the functions of several means recited in the claims and reference signs in the claims shall not be construed as limiting the scope of the claims.

1. A lamp controller for a lamp in a lighting network, the lamp controller having a commissioning mode of operation and a normal mode of operation and comprising:
a transponder,
a memory for storing commissioning information, and
a processor coupled to the transponder and the memory;
wherein the lamp controller is configured to be operable in the commissioning mode
to transmit the commissioning information by modulating the light output of a light source coupled to the lamp controller, and
to receive a network key via the transponder, and
wherein the lamp controller is configured to be operable in the normal mode to communicate with other network devices in the lighting network via the transponder.

2. The lamp controller of claim 1 wherein the commissioning information comprises an address of the lighting apparatus.

3. The lamp controller of claim 1 wherein the commissioning information comprises a unique security key.

4. The lamp controller of claim 3 wherein the received network key is encrypted using the unique security key.

5. The lamp controller of claim 1 wherein the transponder is coupled to an antenna, and wherein the lamp controller operable according to at least one of the Zigbee standard protocol and the Jennet-IP protocol.

6. A lamp comprising a light source and the lamp controller according to claim 1 wherein the processor is coupled to the light source.

7. A lighting network comprising at least one lamp controller according to claim 1.

8. A detector for commissioning a lamp controller in a lighting network, the detector comprising:
a photosensor,
a transponder, and
a controller coupled to the photosensor and the transponder;
wherein the detector is configured to be operable to detect commissioning information transmitted from a light source coupled to a lamp controller via the photosensor, and to transmit the received commissioning information via the transponder.

9. The detector of claim 8, wherein the detector is configured to be further operable to: determine a location of the detector corresponding to the location of a lamp controller in response to detecting the commissioning information.

10. The detector of claim 9 further comprising an orientation sensor, wherein the detector is configured to be further operable to determine a location of a lamp from the location and orientation of the detector in response to detecting the commissioning information.

11. The detector of claim 9 wherein the detector is further configured to be operable to:
wirelessly transmit data for determining a time-of-flight from the detector to at least two transponders, each of the at least two transponders having a predetermined fixed location;
wirelessly receive data for determining a time-of flight from each of the two lamps being commissioned;
determine a distance between the detector and each of the at least two transponders; and
determine the location value of the detector from the determined distances.

12. A mobile phone comprising the detector of claim 8.

13. A method for commissioning a lamp controller into a network, the lamp controller comprising a transponder, the method comprising:
configuring the lamp controller into a commissioning mode of operation;
configuring the lamp controller to transmit commissioning information by modulating the light of a light source coupled to the lamp controller;
receiving a network key via the transponder; and
configuring the lamp controller into a normal mode of operation;
wherein in the normal mode of operation the lamp controller communicates with other network devices on the network via the transponder.

14. The method of claim 13 further comprising: providing a detector comprising a photosensor and a transponder; detecting the commissioning information transmitted by the lamp by means of the photosensor; and transmitting a network key to the lamp controller by means of the transponder of the detector.

15. The method of claim 13 further comprising determining a location of the lamp controller from the location of the detector.
